(19) United States
(12) Patent Application Publication
(10) Pub. No.: US 2015/0239651 A1
(43) Pub. Date: Aug. 27, 2015

(54) METHOD FOR CONSUMING ALCOHOLIC BEVERAGE

(71) Applicant: LENOX LESLIE, LONDON (CA)

(72) Inventor: LENOX LESLIE, LONDON (CA)

(21) Appl. No.: 14/188,815

(22) Filed: Feb. 25, 2014

(51) Int. Cl. B65D 85/78; B65D 47/36; B65D 33/00; C12G 3/06; B65D 85/72

(52) U.S. Cl. CPC B65D 85/78; C12G 3/06; B65D 85/72; B65D 33/008; B65D 47/36

(57) ABSTRACT

The present invention introduces a novel system for consuming an alcoholic beverage. The alcoholic beverage is presented for the consumer in plastic sealed bags. The alcoholic beverage is prepared and packaged in a specific shape in order to be served without any preparation and without the need for any container.

### FIELD OF THE INVENTION

The field of present invention relates generally to the specific consumption of alcoholic beverage.

### BACKGROUND OF THE INVENTION

There are several issues in serving alcoholic beverage in parties and clubs. One is preparing a specific cocktail for a large number of people. This is not only time consuming, but requires a large number of serving glasses, which have to be cleaned at some point. Unfortunately, many times, the cleanliness of the cups and glasses is compromised in order to expedite the serving process. This increases the possibility of contaminations and spreading of bacteria and viruses. In addition, the quality and consistency of a mixed drink depends on the quality of its ingredients and also on the bartender making it. Additionally, some clubs and certain public events may not be able to provide certain types of cocktails because they may need a specific tool for making the drink or certain measuring equipment. Generally, preparing a large variety of cocktails for a large group of people has many issues. Providing pre-prepared and hygienically packaged alcoholic drinks can resolve these issues.

Alcoholic consumption has been associated with an increased risk of hangover. One of the reasons for hangover is dehydration. Alcohol acts as a diuretic and causes loss of water. Excessive loss of body water can result in dehydration. When consuming too much alcohol, a person may lose water at a rate which cannot be replaced quickly enough. Therefore, one of the ways to prevent a hangover is to drink plenty of water before and after drinking alcohol. However, most users do not drink enough water with their drinks. Providing alcohol in a gelatinous form can allow for slower absorption of the alcohol and may prevent hangover from dehydration.

There have been some attempts in the prior art to address the above issues. U.S. Pat. No. 4,790,999 issued to Ashmount et al. disclosed a ready-to-consume, freezable alcoholic beverage comprising of water, sugars, alcohol, flavoring and carboxymethyl cellulose. The alcoholic beverage is packaged in a sealed plastic container with the container having a size of one liter or less.

U.S. Pat. No. 6,162,468 issued to Stanley et al. disclosed a frozen composition comprising of an active ingredient in a sealable plastic container which provides nutritional supplements for children. The frozen composition does not list alcohol in its composition.

The manner in which people consume alcohol has generally not changed over time. In such a community, there is a need to change a traditional way of alcoholic beverage consumption to the new way in that people can be protected from various issues that arise from alcohol consumption and provide ways of enhancing the experience of alcoholic consumption.

### SUMMARY OF THE INVENTION

The present invention introduces a novel system for consuming an alcoholic beverage. The alcoholic beverage is presented for the consumer in plastic sealed bags. The alcoholic beverage is prepared and packaged in a specific shape in order to be served without any preparation and without the need for any container.

The first objective of the present invention is to provide an already prepared alcoholic beverage. The alcoholic beverage is made ready to consume and there is no need for preparation during a party or an event. Users can have a specific cocktail without waiting for it to be prepared.

The second objective of the present invention is to provide an innovative way of consumption of alcoholic beverages. With using the present invention, there is no need for any kind of glasses and containers.

The third objective of the present invention is to provide a hygienic way of consumption of alcoholic beverage for the users. The container of the alcoholic beverage is made for one use only and is disposable. Users are therefore assured that they are the only ones that have consumed the product.

The fourth objective of the present invention is to provide a safe way of consuming an alcoholic beverage which is convenient for all users. In addition to it being more hygienic, the present invention can be safer than alcohol served in glasses. A user is given a sealed package, which would make any tampering without doing any damage to the package highly unlikely. The drink is also in a gelatinous form so dissolving of any unknown foreign substances is again very unlikely.

The fifth objective of the present invention is to provide different percentage of alcoholic beverage in the specific disposable container. The present invention is already prepared with four levels of alcohol percentage: “Virgin,” which contains no alcohol, “Innocence,” which has a slight taste of alcohol, “Maturity” which has a definite taste of alcohol, and “Aged” which has a strong presence of alcohol.

The sixth objective of the present invention is to provide a novel way of consuming of alcoholic beverage, which prevents hangover. By such a way of consumption, the user should keep the alcoholic beverage in his/her mouth for more time so the water in the gelatine can absorb faster than the traditional way of alcoholic consumption.

The aforementioned objects of the present invention are attained by an gelatinous alcoholic beverage in a plastic bag having an opening part and equipped with an easy opener. Other objects, advantages and novel features of the present invention will become readily apparent from the following drawings and detailed description of preferred embodiments.

### BRIEF DESCRIPTION OF THE DRAWINGS

Embodiments herein will hereinafter be described in conjunction with the appended drawings provided to illustrate and not to limit the scope of the claims, wherein like designations denote like elements. The drawings are described as follows:

FIG. 1 shows a plastic bag container with an alcoholic beverage;

FIG. 2 shows a series of plastic bag which filled by an alcoholic beverage;

FIG. 3 shows a series of plastic bags which is carried by a user in a party or clubs;

FIG. 4 shows another embodiment of a series of plastic bags which is carried by a user in a party or clubs;

FIG. 5 shows a pillow shaped bags which fits a number of plastic bags; and

FIG. 6 shows a series of pillow shaped bags which contain different kind of alcoholic beverages.

### DETAILED DESCRIPTION OF THE PREFERED EMBODIMENTS

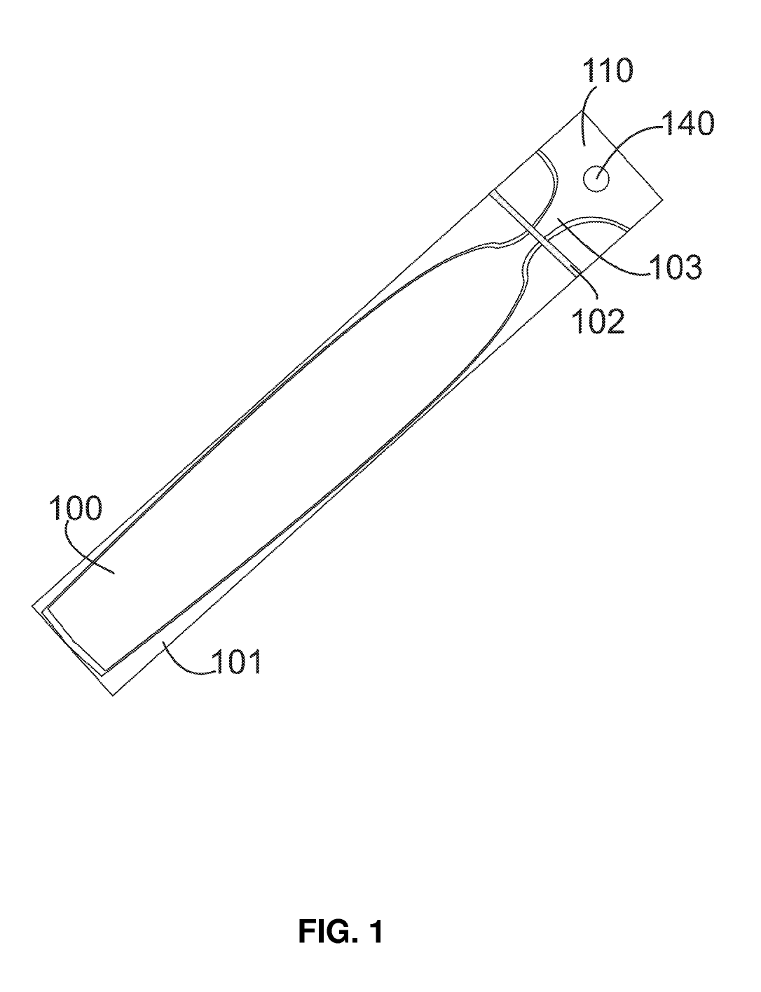

Referring to FIG. 1, the beverage 100 is placed inside a polypropylene film or wrap 101. Each individual packet 110 is placed inside the film or wrap and then is sealed with heat or vacuum-sealed inside the polypropylene film/wrap. Each packet contains an indentation or perforation 102 along one end of the package where filling space narrows. The perforation and indentation is to allow for easy tearing of the top of the film or wrap so that it allows users to drink the beverage. Prior to the perforation or indentation 102 the inner portion of the tube or film narrows to form a narrow passage 103 for the beverage 100 to squeeze through. An individual packet also possess a hole 140 at the distal end which can be used for carrying when attached to other packets.

A variety of alcoholic drinks can be placed inside the wrap 101. Gelatine shooters can be prepared with heated filtered water, which is then whisked with a flavoured gelatine mix for about three minutes or until the desired handling temperature has been reached. Chilled premium vodka is then added to the room temperature gelatine and water mixture. Lime juice, unflavoured gelatine, and sweetener may also be added depending on the specific flavour.

Other embodiments of the invention can include alcohol containing ice cream. The ice cream is prepared with room temperature ice cream and selective chilled liquors. The mixture of ice cream and chilled liquors is then blended on a low setting using a mixer or blender for about 2 minutes while an additional 10% of the products volume is added in the form of pasteurized whole cream. The ice cream is then packaged with heat and vacuum seal in the specially designed polypropylene film/wrap.

Another embodiment can include a custom “sprits” beverage. A custom mix of alcoholic drinks is created and made to contain double the amount of alcohol of a regular drink mix. During the packaging process one third of the product volume is comprised of chilled filtered water, which then would dilute the alcohol content to legal consumption levels. The product is then packaged with heat and vacuum seal in the specially designed polypropylene film/wrap.

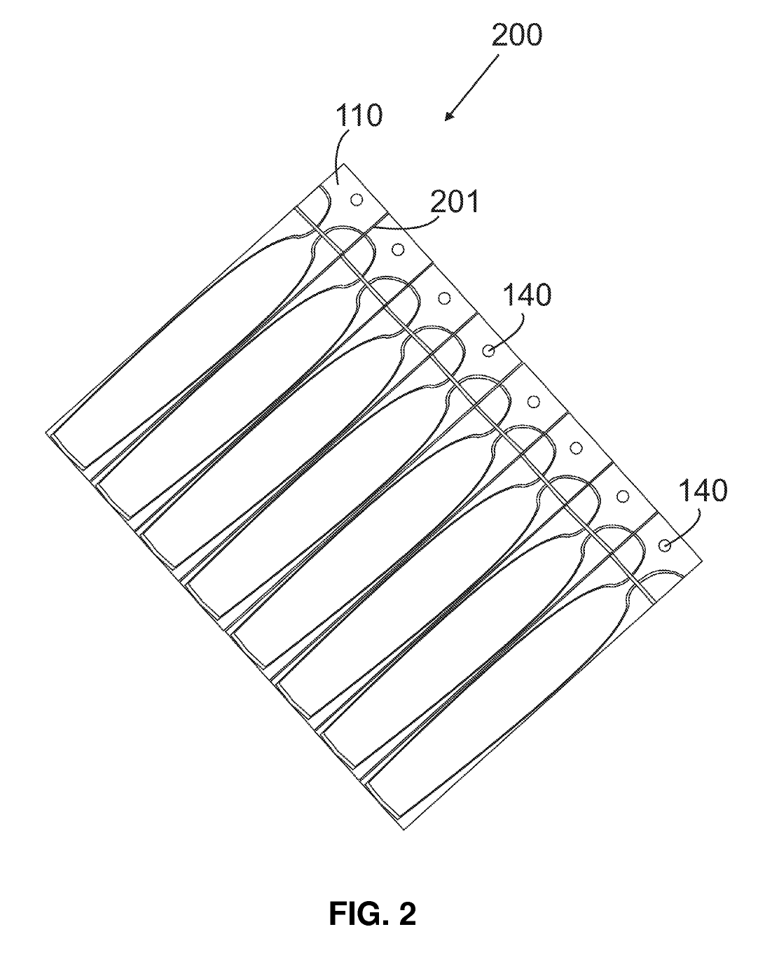

FIG. 2 shows that an individual unit 110 of the polypropylene film or wrap 101 can be created to be located in a package of eight units 200 that are attached together. The multiple single packs 110 can be attached to each other via perforated edges 201 on each side and can be folded to decrease the amount of space required for storage. When a user decides to give an individual packet it can be torn along premade perforated lines that are present on the sides of each individual packet 110.

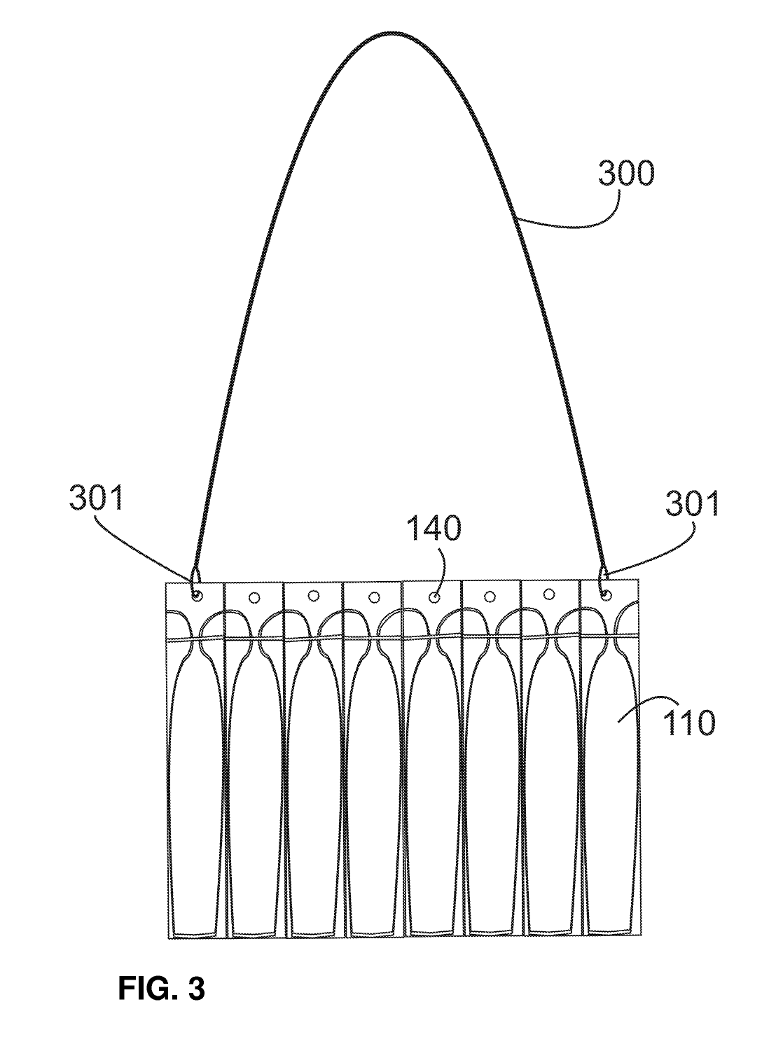

FIG. 3 shows that a package of eight units 200 can be constructed to have a strap 300 and be carried around and consumed while dancing and walking around a club, house and otherwise. This embodiment of the invention can also be used to distribute the individual packages 110 at sporting events or in clubs with sellers walking near the seats of a venue or around the floor of a club. The strap can be attached to one of the holes 140 of the combined package at the two opposing ends with the individual packets being oriented perpendicular to the ground. The strap 300 is attached to the hole 140 by clips 301 which can then be slid along as an individual packet 110 is removed. In this way, multiple packets 110 can be carried with ease and thereby leave the hands free of the person that is responsible for dispensing the packets.

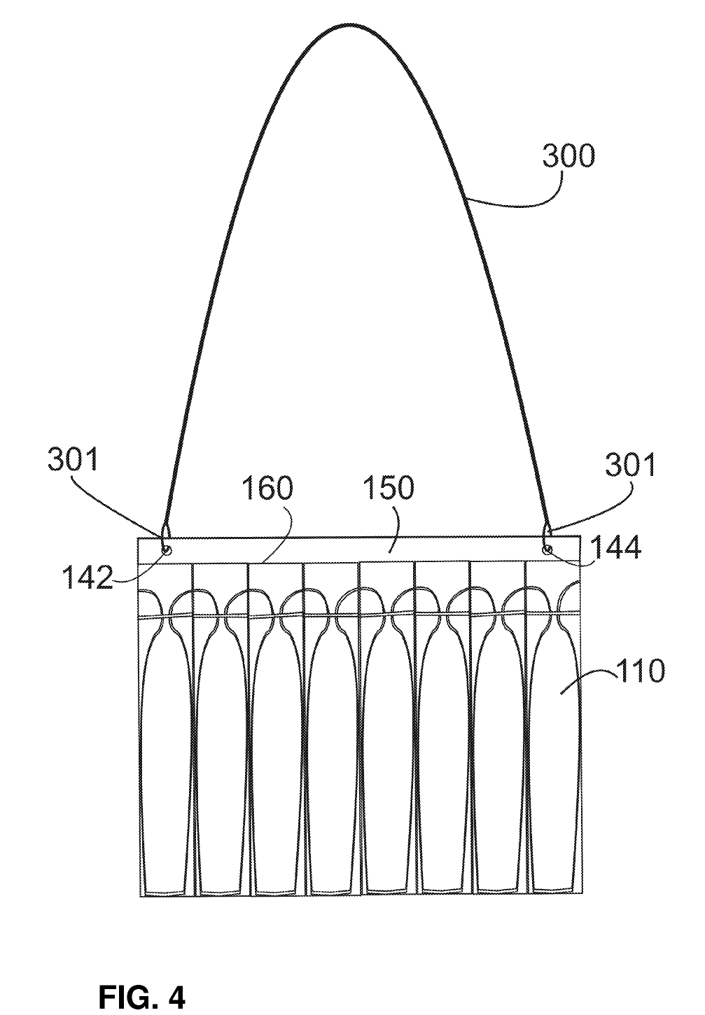

Another embodiment for a package of eight units shown as FIG. 4. In this embodiment, a strap 300 be carried around and consumed while dancing and walking around a club, house and otherwise. There is no need to have plurality of holes 140 for each container. As shown in FIG. 4, a continuous ribbon 150 is on top of each container which has two holes 142-144 at distal and proximal end for carrying the package of eight units 110. Each individual package 110 can be torn along premade perforated line 160 that are present on the bottom of ribbon 150. The strap 300 is attached to the holes 142, 144 by clips 301 which can then be slid along as an individual packet 110 is removed. In this way, multiple packets 110 can be carried with ease and thereby leave the hands free of the person that is responsible for dispensing the packets.

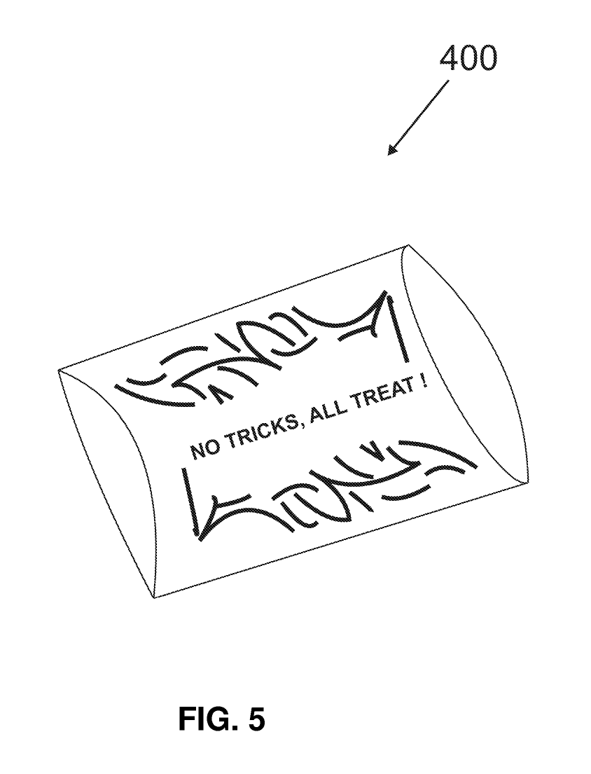

The combined packets of eight individual units can be further packaged in pillow shaped bags or boxes 400, as shown in FIG. 5. The pillow shaped bag 400 will hold two packets of eight individual packages or 16 individual packages. One package of eight individual beverages is stacked on top of the second package and two carrying straps 300 can also be included in the pillow shaped bag.

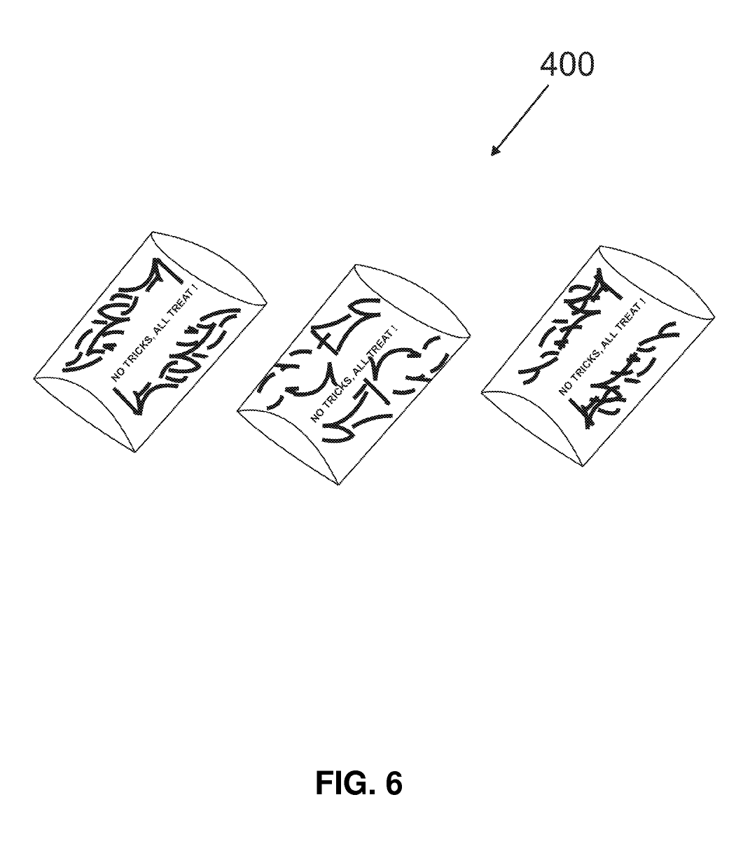

The design and colour of each pillow shaped container bag 400 can be such that it would indicate and represent the flavours or types of drinks that are in the containers. As shown in FIG. 6, there can be a number of different types of packaging in order to represent the various flavours or types of product that can be available.

Other embodiments of this invention can include using non-alcoholic drinks. For example, performance or energy drinks can be made to use in the same packaging. In this way, they can be easily made available to athletes who are in middle of endurance races such as marathons or long-distance bicycle races or any other sports activity. Additionally, drinks containing nutritional supplements can be placed in the packaging for ease of use.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A method for consuming a gelatinous alcoholic beverage comprising:
a. preparing said gelatinous alcoholic beverage comprising:
i. at least 10 percent by weight alcoholic spirit;
ii. at least 10 percent by weight gelatinous powder;
iii. at least 1.5 percent by weight sweetener;
iv. at least 1.5 percent by weight carbohydrates;
v. at least 0.5 percent by weight sodium; and
vi. water;
b. packaging said alcoholic beverage in a plastic bag container; and
c. using said gelatinous alcoholic beverage by tearing a distal end of said plastic bag container.

2. A method for consuming an ice cream alcoholic beverage comprising:
a. preparing said ice cream alcoholic beverage comprising:
vii. at least 15 percent by weight alcoholic spirit;
viii. at least 50 percent by weight dairy product;
ix. at least 5 percent by weight sweetener;
x. at least 25 percent by weight a food flavor; and
xi. at least 5 percent by weight a food coloring;
d. packaging said ice cream alcoholic beverage in a plastic bag container; and
e. using said ice cream alcoholic beverage by tearing a distal end of said plastic bag container.

3. The method for consuming an alcoholic beverage of claims 1 and 2, wherein said plastic bag container comprises a substantially cylindrical flexible sealable container with an opening at said distal end of said plastic bag container.

4. The method for consuming an alcoholic beverage of claims 1 and 2, wherein said distal end of said plastic bag container having an indentation or a perforation for easy opening.

5. The method for consuming an alcoholic beverage of claims 1 and 2, wherein distal end of said plastic bag container having an inner portion to form a narrow passage for the beverage squeeze through.

6. The method for consuming an alcoholic beverage of claim 2, wherein said dairy product selected from the group consisting of milk, cream, and a powder milk.

7. The method for consuming an alcoholic beverage of claims 1 and 2, wherein said plastic bag container sized to hold about 20 to 50 milliliters of said alcoholic beverage.

8. The method for consuming an alcoholic beverage of claims 1 and 2, wherein said plastic bag container selected from the group consisting of clear flexible plastics and opaque flexible plastics.

9. The method for consuming an alcoholic beverage of claims 1 and 2, wherein said plastic bag containers being attached to each other via perforated edges on each side and being folded to decrease the amount of space required for storage.

10. The method for consuming an alcoholic beverage of claim 1, wherein said plastic bag container having a hole at said distal end to engage a strap to said hole with a hanging means, wherein said hanging means being a clip with a movable tooth.

11. The method for consuming an alcoholic beverage of claims 1 and 2, wherein said plastic bag container comprises a substantially polyhedronal, elliptical, and spherical flexible sealable container with an opening at a distal end of said plastic bag container.

12. The method for consuming an alcoholic beverage of claims 1 and 2, wherein said plastic bag container being connected to each other by a strap for carrying a package of plurality of said plastic bag container with a user, wherein said package having two holes at a distal and a proximal end of a ribbon on top of said plastic bag container which connect said strap to said ribbon.
